(19) United States
(12) Patent Application Publication
(10) Pub. No.: US 2020/0263846 A1
(43) Pub. Date: Aug. 20, 2020

(54) VEHICLE LIGHT ASSEMBLY WITH QUANTUM DOPED MATERIAL ILLUMINABLE USING DISTINCT ILLUMINATION SOURCES

(71) Applicant: MAGNA CLOSURES INC., Newmarket (CA)

(72) Inventor: Traian MIU, Oakville (CA)

(21) Appl. No.: 16/792,647

(22) Filed: Feb. 17, 2020

Related U.S. Application Data
(60) Provisional application No. 62/807,913, filed on Feb. 20, 2019.

(51) Int. Cl. F21S 41/176; F21S 41/32; F21S 43/16; F21S 43/30; F21S 41/145; F21S 41/25; F21S 43/20; F21S 41/64; B60Q 1/04; B60Q 1/44

(52) U.S. Cl. CPC F21S 41/176; F21S 41/321; F21S 43/16; F21S 43/30; F21S 41/145; F21Y 2113/10; F21S 43/26; F21S 41/645; B60Q 1/04; B60Q 1/44; F21S 41/25

(57) ABSTRACT

A light assembly for a vehicle includes quantum dots that are excitable by sources of electromagnetic radiation. The assembly may include a lens and a reflector, and the quantum dots may be disposed adjacent the reflector and/or in the lens. A controller may receive a signal to produce a particular color and activate one or more source of electromagnetic radiation, and one or more subsets of the quantum dots may be excited in response to activating the particular source of electromagnetic radiation. The assembly may include a panel having quantum dots embedded therein. The panel may be illuminated by the quantum dots in response to activating one or more source of electromagnetic radiation. The panel may have different zones with different quantum dots that produces distinct areas with different colors. The sources of electromagnetic radiation may be activated separately to produce different colors or simultaneously to produce a blended color.

### CROSS-REFERENCE TO RELATED APPLICATIONS

This application claims the benefit of U.S. Provisional Application No. 62/807,913, filed Feb. 20, 2019, and titled “Vehicle Light Assembly with Quantum Doped Material Illuminable Using Distinct Illumination Sources,” which is hereby incorporated by reference in its entirety. The entire disclosure of the above application is incorporated herein by reference.

### FIELD

The present disclosure relates generally to a vehicle light assembly. More particularly, the present disclosure is directed to a vehicle light assembly with quantum doped material illuminable using distinct light sources.

### BACKGROUND

This section provides background information related to vehicle lighting systems and is not necessarily prior art to the lighting of the present disclosure.

Motor vehicles, including electric vehicles, internal combustion vehicles, and hybrid vehicles, include a variety of lighting needs integrated with the vehicle body. For example, these vehicles typically include headlights, taillights, signaling lights, such as turn signal blinkers, reverse indicator lights, etc.

Typically, each of these different types of lights on the vehicle can have a different color corresponding to traditional and expected types of illumination for various functions. The lights are typically constructed to include a light source, such as bulb. The bulb may be an LED bulb, incandescent, fluorescent, or halogen type bulb configured to emit a “white” or “yellow” light color. A reflector, often having a “silver” color may be used to reflect and focus the light on a lens. The lens will receive the reflected light, and allow the light to pass through and be further focused, if desired.

Headlights or headlamps may typically be arranged to include a generally clear lens, such that the reflected light will be emitted from the lens having a color corresponding to the color of light emitted from the bulb. In some cases, users may prefer headlights having LED bulbs that emit a light having a “white” appearance, which may be more aesthetically pleasing. Taillights typically include a lens having a red color, such that the light passing through the lens has a red appearance. Similarly, brake lights, when actuated, may be contained within the same housing as the taillight and may emit an additional amount of light when the brakes are activated. Signal lights, such as turn signals or blinkers, may include a red or orange lens that produces a corresponding color when the signals are activated.

Accordingly, to provide a vehicle having the capability of emitting different colored light for different purposes, the vehicle may include light assemblies having multiple housings and multiple different lenses to produce the desired color at different locations of the vehicle corresponding to the desired functionality of the lights.

The various number of lights and housings therefore requires additional expense and installation costs, and typically results in a limited degree of adaptability and modification.

While current light assemblies are sufficient to meet regulatory requirements and basic user functionality, a need still exists to advance the technology and provide alternative arrangements that address and overcome at least some of the known shortcomings.

### SUMMARY

This section provides a general summary of the disclosure and is not intended to be a comprehensive disclosure of its full scope or all of its features, aspects, advantages and objectives.

It is an aspect of the present disclosure to provide a vehicle light system capable of producing multiple colors from a common lens.

It is an aspect of the present disclosure to provide a vehicle light system with reduced size.

It is an aspect of the present disclosure to provide a vehicle light system that is aesthetically pleasing.

In accordance with these and other aspects, a light assembly for a vehicle is provided that includes at least one source of electromagnetic radiation configured to emit electromagnetic radiation in at least a first direction; a light output structure configured to display colors emitting therefrom; a plurality of quantum dots, wherein a first subset of the plurality of quantum dots are configured to display a first color in response to excitation by the at least one source of electromagnetic radiation, and a second subset of the plurality of quantum dots are configured to display a second color in response to excitation by the at least one source of electromagnetic radiation; and a controller in operative communication with the at least one source of electromagnetic radiation, the controller configured to selectively activate the at least one source of electromagnetic radiation for exciting one or both of the first and second subsets of the plurality of quantum dots in response to a signal.

It is a related aspect of the present disclosure to provide a method for producing different colors in a light assembly. The method includes the steps of, at a controller, receiving a first signal to produce to a first light color; in response to receiving the first signal, activating a first source of electromagnetic radiation; receiving light from the first source of electromagnetic radiation at a first subset of quantum dots and, in response thereto, exciting the first subset of quantum dots to produce the first color; at the controller, receiving a second signal to produce a second color; in response to receiving the second signal, activating a second source of electromagnetic radiation; receiving electromagnetic radiation from the second source of electromagnetic radiation at a second subset of quantum dots and, in response thereto, exciting the second subset of quantum dots to produce the second color.

Further areas of applicability will become apparent from the description provided herein. The description and specific embodiment disclosed in this summary are not intended to limit the scope of the present disclosure.

### DRAWINGS

The foregoing and other aspects of the present disclosure will now be described by way of non-limiting examples with reference to the attached drawings in which:

FIG. 1 is a schematic view of a vehicle light system having a reflector, a quantum layer having quantum dots, a lens, multiple light sources, and a controller, with the light sources activated at the same time to produce a blended color output;

FIGS. 2A and 2B are schematic views of the light system of FIG. 1 illustrating activation of light sources separately to produce different colors;

FIG. 3 is partial perspective view of a vehicle with a prior art light module with separate lenses to produce different colors;

FIG. 4 is a partial perspective view of the vehicle light system of FIG. 1 in which a common lens produces different colors;

FIG. 5 is a schematic view of another light system in which a lens has quantum dots applied thereto;

FIG. 6 is a schematic diagram of the vehicle light system;

FIG. 6A is another schematic diagram of the vehicle light system;

FIG. 7 is a flow chart illustrating an control aspect of the vehicle light system;

FIG. 8 is another flow chart illustrating another control aspect of the vehicle light system;

FIGS. 9A and 9B illustrate a prior art light module for a vehicle;

FIGS. 9C and 9D illustrate another aspect of the light system in which a panel having quantum dots is backed with a backing layer to replace a traditional light module;

FIG. 10 is rear perspective view of a vehicle having the vehicle light system;

FIG. 11 is a schematic view of another aspect of the light system where the light sources are behind the panel having quantum dots;

FIG. 12 is a schematic view of another aspect of the light system where the light sources are adjacent an edge of the panel having quantum dots;

FIG. 13 is a schematic view of another aspect of the light system where the light sources are disposed on opposite edges of the panel having quantum dots;

FIG. 14 is schematic view illustrating a panel having quantum dots in different zones of the panel;

FIGS. 15A and 15B are schematic views of a panel having different zones arranged in the shape of a logo;

FIG. 16 is a schematic view of another aspect of the light system in which an LCD stack includes quantum dots; and

FIG. 17 is a schematic view illustrating a prior art multi-color lens replaced with a panel having quantum dots that displays more than one color over a common surface area to reduce overall size of the light system or increase the illuminated area of more than one color.

Corresponding reference numerals are used throughout the several views of the drawings to indicate corresponding components unless otherwise indicated.

### DETAILED DESCRIPTION

Example embodiments of light assemblies are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

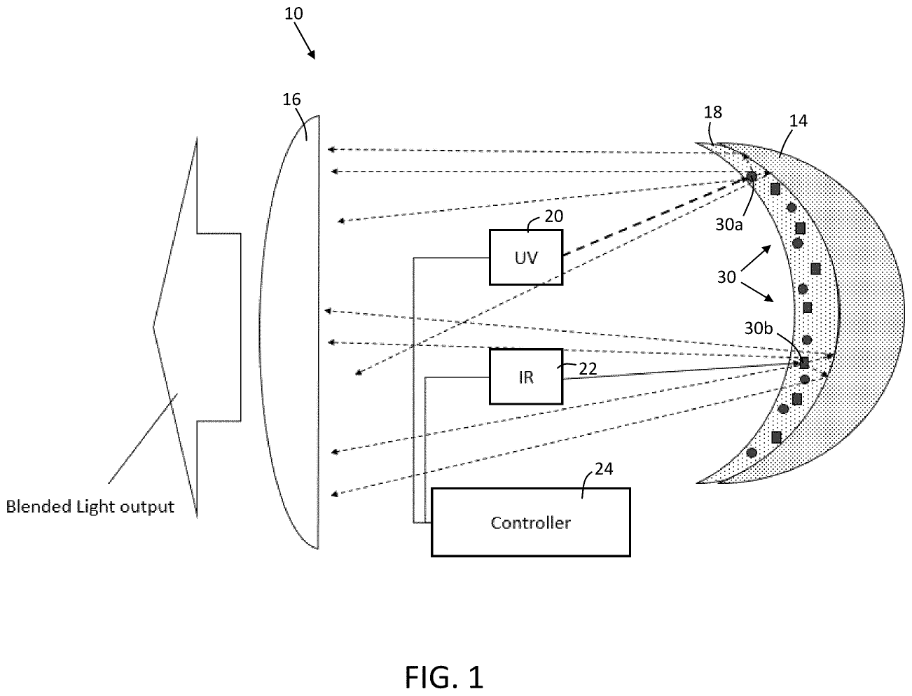

With reference to the figures, a light system 10 for a vehicle 12 is shown. As shown in FIG. 1, the system 10 may include a reflector 14, a lens 16, and a quantum layer 18. The system 10 may further include a first light source 20 and a second light source 22, each configured to direct light toward the quantum layer 18. The light sources may also be referred to as a source of electromagnetic radiation, as the source may emit non-visible light. The system 10 may further include a controller 24 in communication with the light sources 20, 22 for selectively activating the light sources 20, 22.

The light sources 20 and 22 may be different types of light sources. For example, the first light source 20 may be a UV light source and may also be referred to interchangeably as UV light source 20. The second light source 22 may be an infrared light source, and may also be referred to interchangeably as IR light source 22. It will be appreciated that the first light source 20 or second light source 22 could be UV, IR, or other type of radiation producing light source.

The light sources 20, 22 are configured to transmit light toward the reflector 14, which is configured to reflect the light toward the lens 16 in a traditional manner. However, unlike a traditional reflector, the light transmitted from the light sources 20, 22 may first pass through the quantum layer 18, which is configured to create a specific color and/or light pattern.

The quantum layer 18 may be applied to the surface of the reflector 14 that receives the light from the light sources 20, 22. The quantum layer 18 may include a plurality of quantum dots 30. Quantum dots are known in the art, and are a nanoscale particle of semiconducting material. A typical quantum dot may be 10 to 50 atoms in diameter (2-10 nm in diameter). Quantum dots are also known as artificial atoms. Based on their size, quantum dots have optical and electrical properties that are intermediate between discrete molecules and a bulk semiconductor. Due to their small size, quantum dots have an unusually high ratio of surface atoms to bulk atoms. Because of their small sizes, quantum dots may be better understood by quantum physics than classical physics. Due to their small scale, the excitons are quantum confined in all three planes. Energy is absorbed and released in discrete quantums. A quantum dot is an example of a photo-luminescent particle that in response to excitation, such as photoluminescence excitation or electroluminescence excitation as examples, causes their electrons to shift between bands and in doing so visible light in a spectral range is emitted. Other types of conversion elements or particles are contemplated herein. One illustrative type of quantum dot is described in United States patent application number 2018/0371312A1 entitled “Conversion element, optoelectronic component provided therewith, and method for manufacturing a conversion element”, the entire contents of which are incorporated herein by reference.

Excitons in quantum dots are confined in all three planes, and therefore can be understood as being confined in a quantum box. Quantum dot dimensions are smaller than the Bohr radius of the excitons (the distance between the excited electrons and hole), therefore the electrons can only be excited by discrete and narrow band energy levels (i.e. quantization of the energy levels as per Pauli's exclusion principle). As the size of quantum dots increases, the band gap (distance between the valence and conduction band) decreases. Accordingly, less energy is needed to excite the electrons in the quantum dot and less energy is released when the electron drops to its ground state.

Energy released by excited electrons dropping to their ground state is released primarily as photons. Therefore, quantum dots can emit very narrow band light with wavelengths closely related to the quantum dot size. Quantum dots can be excited by either photon absorption (photoluminescence) or by electric fields (electroluminescence). Typically, higher energy photons (UV light) are absorbed and lower energy photons are emitted (visible light).

Quantum dots can come in different forms. One type of quantum dot is a core-type quantum dot. A core-type quantum dot is in the form of a single component material with uniform internal composition. First quantum dots were selenides, sulfides, or tellurides of metals like cadmium, lead or zinc. Presently, cadmium and lead-free quantum dots are being produced. The photoluminescence and electroluminescence properties can be tuned by changing the size of the crystal.

Another type of quantum dot is a core-shell quantum dot. In this type, the recombination of electron-hole pairs (exciton delay) is usually through radiative pathways. When exciton delay occurs through non-radiative methods, the quantum yield is reduced. To improve quantum yield by passivating nonradiative recombination sites, quantum dot cores can be encased in shells of higher band gap semiconducting material.

Yet another type of quantum dot is an alloyed quantum dot. In applications with size restrictions, tuning the properties of quantum dots by tuning their size may not be possible. Multicomponent (alloy) quantum dots can be tuned by changing the crystal composition rather than the size of the crystal. Alloyed quantum dots display properties distinct from those of their bulk counterparts as well as those of their parent semiconductors. Alloyed nanocrystals possess novel and additional composition-tunable properties aside from the properties that emerge due to quantum confinement effects.

In using quantum dots in automotive applications, the quantum dots 30 may be manufactured in different ways. For example, self-assembled quantum dots may be used, having 5 to 50 nm diameters. Viral assembly may be used, which are genetically modifiable bacteriophage viruses. Electrochemical assembly may be used, which are self-replicating quantum dots. In bulk manufacture, colloidal solutions may usually be used.

Quantum dots are presently produced by many companies in Kg quantities. For example, one liter (100 cm cubed) of quantum dots can cover an area of 10,000 square meters when layered 100 nm thick.

Quantum dots are presently used in various applications, such as solid state lighting due to the tunable electroluminescence and photoluminescence. Quantum dots are also used in ultrathin displays, photovoltaics (PV cells, sensors, etc.), ultrafast electronics (short distance the electrons can travel), quantum computing, biosensors, and dies for medical diagnosis.

In the present application, the quantum dots 30 may be used to produce light for headlights, taillights, and the like. In these cases, both photoluminescence and electroluminescence can be used.

In the case of headlights, by combining different spectrums, white light of any color rendering index (CRI)/spectrum can be achieved. High CRI light can improve nighttime visibility compared to lower CRI light of the same intensity. CRI is a scale from 0 to 100 percent indicting how accurate a given light source is at rendering color when compared to a reference light source. The higher the CRI, the better at color rendering ability.

Photoluminescence headlights may operate similarly to laser headlights. For example a UV or blue diode can pump a layer of quantum dots. However, relative to laser headlights, quantum dots have a much better and more tunable color spectrum. In the case of headlights, implementation may depend on the possible quantum yield or efficiency at high emissivity. Daytime running lights may be implemented more quickly and easily than full headlights.

In the case of taillights, lower efficiency may be sufficient, due to the lower intensity of tail lights and the use of single color light.

Quantum dots for lighting in automotive applications may provide a number of benefits. For example, quantum dots may provide greater styling freedom relative to traditional light assemblies. The quantum layer 18 may simply be printed onto a clear polymer material, or may be injection molded into the polymer material. Quantum dots may be used to create uniformly lit areas or patterned/pixelated areas, as desired. Quantum dots may be used as a replacement for light pipes. Quantum dot materials may be translucent, and therefore clear lens may be made to emit light. In some cases, a clear polymer layer may be backpainted the color of the vehicle body, and the layer may then effectively disappear when “off” and may emit light when “on.” Similarly, thin film light can be easily produced for interior/exterior styling. The quantum dot light emitting materials can be painted on or molded into the vehicle body at a variety of locations.

Quantum dots may also be used as part of automotive mirrors or displays. For example, quantum dots 30 may overlay on inside mirrors and outside mirrors, and information may be presented on the reflective surface of the mirror by illuminating the quantum dots 30. In another aspect, the quantum dots 30 may be printed on a vehicle windshield to eliminate the inside rearview mirror.

A transparent quantum dot display may be applied over an entire surface or substantially the entire surface of a windshield to be used as a HUD or augmented reality display. A transparent quantum dot display may be applied on the entire surface of a backlight or side windows and used for augmented reality.

Quantum dot displays may be added to the roof or sunroof of a vehicle for styling or occupant comfort, or as an energy harvester in the case of a photovoltaic. Quantum dot displays may also be used for holographic displays even in bright conditions. Quantum dot displays may be integrated into flexible displays and touchscreens for interior instrumentation or infotainment.

In the case of an electroluminescent application, a printed or molded layer of quantum dots 30 may be sandwiched between an Indium Tin Oxide (ITO) layer and a reflective or ITO layer, the assembly of which form an electric circuit. Accordingly, a voltage may be applied across the layers, resulting in exciting the quantum dots and producing a particular color profile, from which light may be emitted and/or reflected from the reflective layer.

In the case of a photoluminescent application, a printed or molded quantity of quantum dots 30 may be positioned adjacent a light source, such as a UV light source or a blue LED. Light emitted from the light source will excite the quantum dots 30 and produce the tuned color corresponding to the quantum dots 30.

Having described the capabilities and benefits and various uses of the quantum dots 30 in automotive applications, additional embodiments and aspects of the quantum dots 30 will now be described.

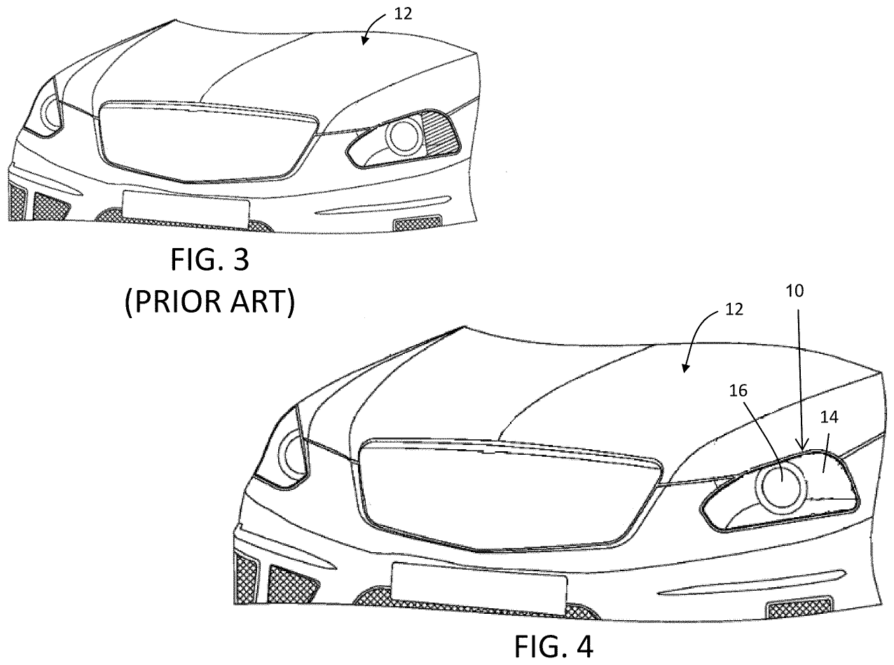

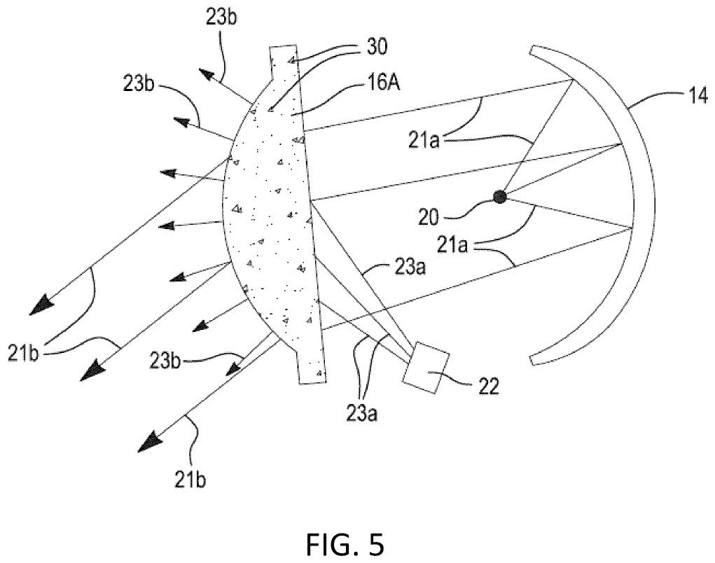

With reference to FIG. 4, the system 10 may be used as a replacement for a traditional front headlight assembly 11, and may be installed in place of the traditional cavity in which a traditional headlight is disposed. However, rather than having two different color sources/lenses (as in the prior art arrangement shown in FIG. 3, with white for the headlight and another color for the blinker), a single common lens (the lens 16) may be used, with the reflector 14 visible through the lens 16.

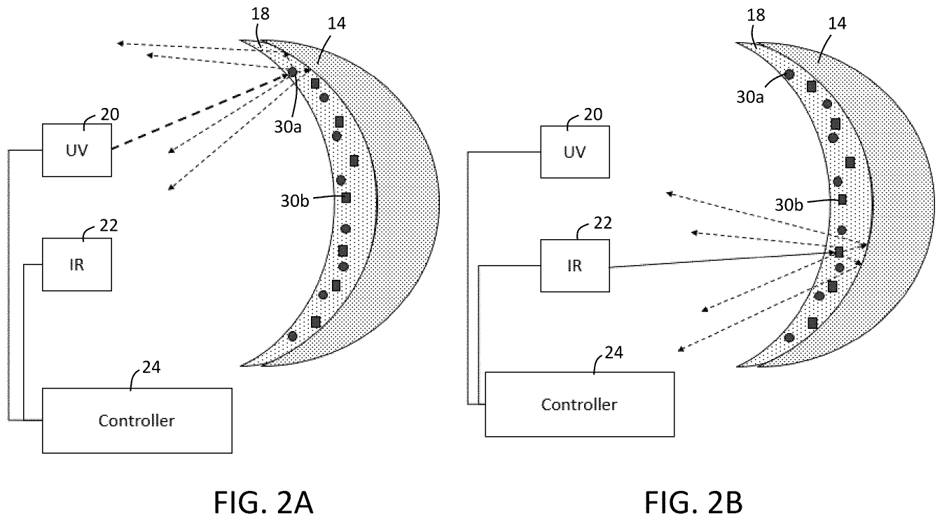

As shown in FIGS. 1 and 2A-B, the quantum dots 30 may be disposed on the quantum layer 18, such as by being printed on the layer 18 or molded into the layer 18. The layer 18 may be a clear polymer or the like. The layer 18 may be molded in a shape corresponding to the shape of the reflector 14. In one approach, the reflector 14 may be in the form of a coating that is applied to the back surface of the layer 18. In another approach, the layer 18 may be printed directly onto the structure of the reflector 14. It will be appreciated that other arrangements of applying quantum dots 30 as the layer 18 that is translucently applied adjacent the reflector 14 may also be used.

The lens 16 may be part of an overall housing that includes the light sources 20, 22 disposed therein, with the layer 18 and reflector 14 disposed at the back portion of the housing. In another aspect, the lens 16 may be separately attached to the housing to allow specific lens types to be interchangeable relative to the housing.

The light sources 20, 22 are operably connected to the controller 24, and may be selectively activated to excite one or more types of quantum dots 30 that are disposed at the layer 18. From a directional perspective, the light sources 20, 22 may be disposed between the lens 16 and the layer 18, as shown in FIG. 1, with the light emitted from the light sources 20, 22 being directed toward the layer 18, such that the light after passing through or exciting the quantum dots 30 will reflect off of the reflector 14 and back toward the lens 16, which may focus the light in a desirable manner.

The controller 24 may be configured to activate one of the light sources 20, 22 followed by the other of the light sources 20, 22, as shown in FIG. 2, which illustrates the first light source 20 and the second light source 22 being activated separately. The controller 24 may also be configured to activate both light sources 20, 22 at the same time, as shown in FIG. 1. The controller 24 may alternate between activating one and/or both of the lights sources 20, 22 at different periods of time. The controller 24 may also be configured to vary the intensity of each light source 20, 22. Thus, the controller 24 may be used to create a variety of colors, including individual colors of varying intensity resulting from each individual light source 20, 22 exciting specific quantum dots 30. The controller 24 may also be used to create a variety of blended colors by activating both light sources at the same time and also varying the intensity of either or both of the light sources 20, 22.

FIG. 2A illustrates an example of the light sources 20, 22 being activated separately to excite different quantum dots. As shown in FIG. 2A, the UV light source 20, which may be a blue LED, may be activated by the controller 24 while the IR light source 22 is not activated. The UV light source 20 is configured to excite the circular shaped quantum dot 30a (the circular shape is for illustrative purposes and is not intended to imply any dimensional aspect of the quantum dots 30), while the square shaped quantum dot 30b (square shape for illustrative purposes) is unexcited. In this approach, for example, a white light, which may also be referred to as color A, may be produced by the quantum dots 30a, such as for daytime running lights.

FIG. 2B illustrates where the IR light source 22 is activated, which excites the square shaped quantum dots 30b, while the UV light source 20 is inactive, and the circle shaped quantum dot 30a is unexcited. In this aspect, a different color, which may be referred to as color B, is produced, such as the color for the turn signal, while the white daytime running light is inactive. In each of FIGS. 2A and 2B, the light from the excited quantum dots 30 reflects off of reflector 14 and is directed toward the lens 16 (not shown in FIGS. 2A and 2B). The controller 24 may activate either of the light source 20 or 22 to alternate between the state shown in FIG. 2A and the state shown in FIG. 2B.

With reference again to FIG. 1, FIG. 1 illustrates the system 10 in which both light sources 20 and 22 are activated by the controller 24 at the same time. The UV light source 20 emits light toward the circle quantum dot 30a, while the IR light source 22 emits light toward the square shaped quantum dots 30b at the same time. Light from both types of dots 30a and 30b is reflected off the reflector 14 at the same time, and is blended together at the lens 16. Thus, blended light is produced and passes through the lens 16, such that at least a third color is produced, which may be referred to as color C. The intensity of each of the light sources 20 and 22 may be varied by the controller 24 to create various types of blended light.

In FIGS. 1-2B, the lens 16 may be a traditional clear lens, such that the light produced by the quantum dots 30 exits the lens 16 appearing the same as that which is reflected. However, it will be appreciated that the lens 16 could also be tinted a different color, such that the light produced by the quantum dots 30 combines with the tint of the lens to produce a different color. For purposes of further discussion, the lens 16 will be considered a clear lens.

In the above examples, two light sources 20 and 22 have been discussed. However, it will be appreciated that additional light sources may also be used, which may be used to excite other quantum dots 30, such that further different colors may be produced, either alone to produce a single color or in combination with other individual colors in a blended light output. Accordingly, the present disclosure should not be interpreted as only including two light sources or two light producing mechanisms.

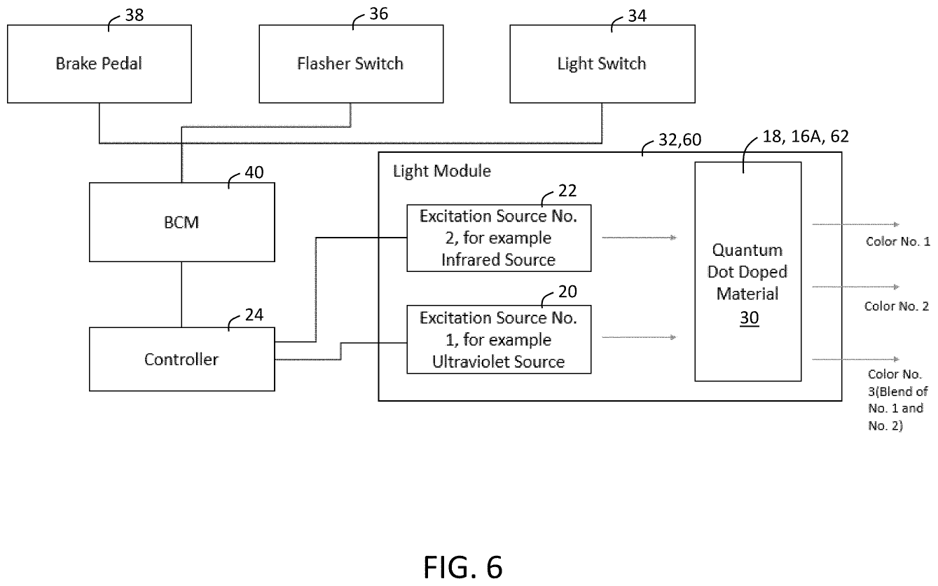

FIG. 5 illustrates an example of an alternative lens 16A, in which the lens 16A resembles the lens 16 in shape, but includes quantum dots 30. The quantum dots 30 may be printed on the surface of the lens 16A or may be molded in the lens 16A. The quantum dots 30 in the lens may be similar to the quantum dots 30b described above, which may be activated by the second light source 22. The first light source 20 produces first light beams 21a, which are directed toward the lens 16A. The first light source 20 may produce the first light beams 21a as a white light that is simply reflected off the reflector 14. In this approach, the reflector 14 may be a traditional style reflector without the layer 18 of quantum dots 30 applied to the reflector. Alternatively, the first light beams 21a may have another color or a non-visible wavelength. The first light beams 21a may be directed directly from first light source 20 to the lens 16A without first being reflected by the reflector 14. Alternatively, the first light beams 21a may pass through another optical device, such as a lens or a filter, disposed between the first light source 20 and the lens 16A.

In this approach, the white light produced by the first light source 20 may be reflected through the lens 16A, which may be focused by the lens 16A to produce second light beams 21b, as desired. For example, the second light beams 21b may take the form of white light that are directed downward toward the road similarly to a traditional headlight. Activation of the first light source 20 may not activate any quantum dots 30 in this approach.

The second light source 22 produces second light beams 23a, which may have a color or non-visible wavelength that is different from the first light beams 21a. The quantum dots 30b that are applied to the lens 16A may be excited by the second light beams 23a, which may be directly projected onto the lens 16A by the second light source 22, as shown in FIG. 5. Alternatively or additionally, the second light beams 23a may be reflected by the reflector 14 or another device and/or transmitted through an optical device, such as a lens and/or a filter. In either case, the quantum dots 30b of the lens 16A may become excited, and may direct light outward from the lens 16A as fourth light beams 23b, which may take the form of diffuse or “unfocused” light. Thus, for example, when the first light source 20 is activated, the lens 16A may create a traditional headlight effect, and when the second light source 22 is activated, the lens 16A may create a diffused light or blinker-type effect having a different color than the headlight. Similar to the arrangement described previously, both light sources 20 and 22 may be activated at the same time to produce a blended light effect.

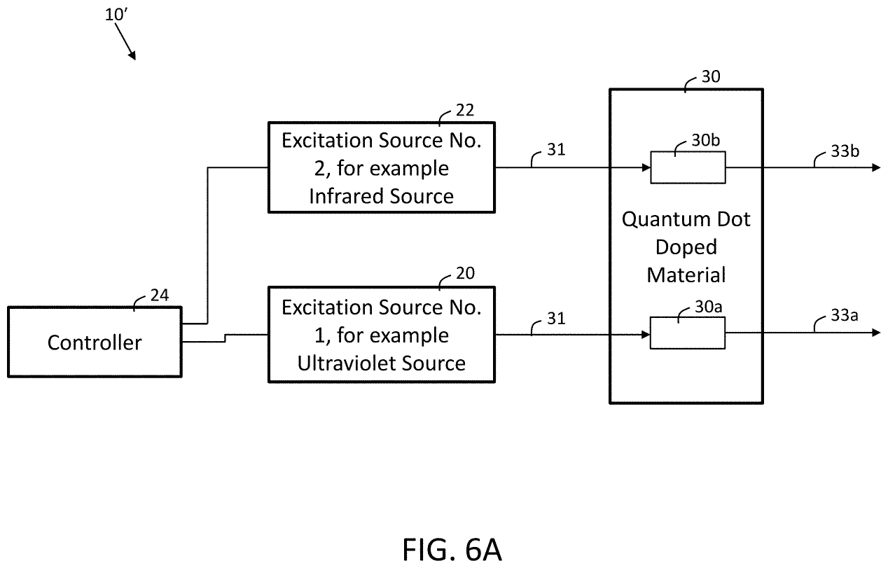

FIG. 6 illustrates one aspect of the system 10 in schematic form. The system 10 may include the controller 24, the light sources 20, 22, and the quantum layer 18 (or other quantum doped structure such as lens 16A). The light sources 20 and 22 may combine with at least the quantum layer 18 to define a light module 32. As described above, the quantum dots 30 or quantum layer 18 may be physically disposed at various locations, such as on the reflector 14 (not shown in FIG. 6) or as part of the lens 16 (not shown in FIG. 6). As shown schematically in FIG. 6, the quantum dots 30 and quantum layer 18 are simply represented as part of the light module 32, and it will be appreciated that various physical locations may be encompassed by this schematic representation.

FIG. 6A illustrates a light system 10′ for a vehicle 12 including at least one electromagnetic radiation source 20, 22 configured to emit electromagnetic radiation 31, and for example each electromagnetic radiation source 20, 22 may be configured to emit different electromagnetic radiation 31, a plurality of quantum dots 30, wherein a first subset 30a of the plurality of quantum dots 30 are configured to display a first color 33a in response to excitation by the emitted electromagnetic radiation 31, and a second subset 30b of the plurality of quantum dots 30 are configured to display a second color 33b in response to excitation by the emitted electromagnetic radiation 31, and a controller 24 in operative communication with the at least one electromagnetic radiation source 20, 22, the controller 24 configured to selectively activate the at least one electromagnetic radiation source 20, 22 for exciting one or both of the first and second subsets 30a, 30b of the plurality of quantum dots 30.

The system 10 may include additional control structure that may ultimately affect how light is generated and displayed. For example, the system 10 may include a light switch 34, a flasher switch 36, and a brake pedal switch 38, all in operative communication with a BCM 40, which is in operative communication with the controller 24. The switches 34, 36, and 38 may operate in a manner similar to known switches, in which actuation or activation of the switch will send a signal to cause a desired illumination. For example, the light switch 34 may be actuated to turn on the headlights, or the brake pedal switch 38 may be activated in response to pressing on the brake pedal, such that a signal is sent to illuminate the brake lights.

FIG. 6 illustrates that light may emanate from the light sources 20, 22 toward the quantum dots 30, thereby generating one or more colors depending on which light source or sources are activated, such as a first a color, a second color, or a third color formed by a blend of the first and second colors.

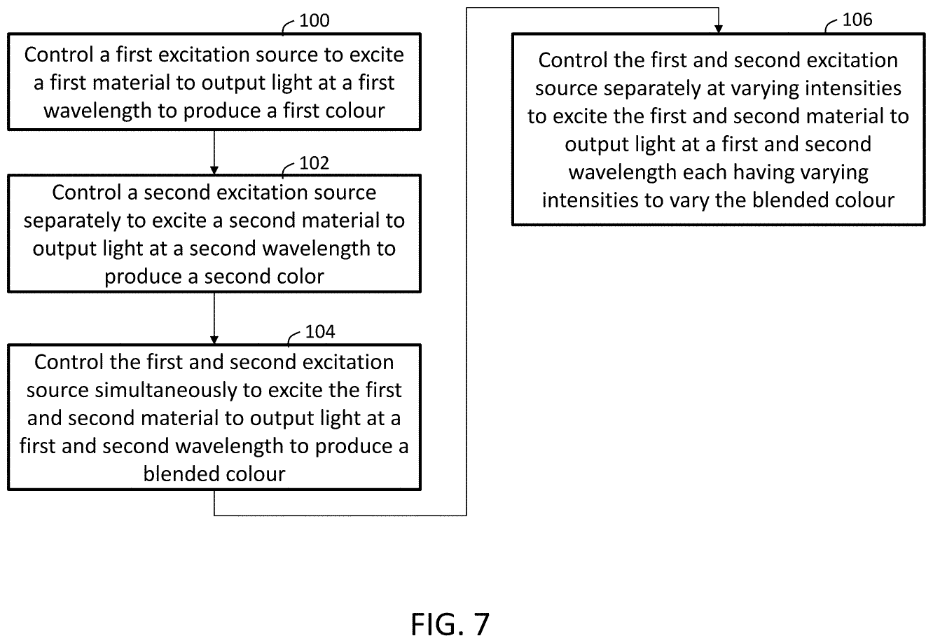

FIG. 7 illustrates a flow chart for controlling the system 10 and generating different colors. At step 100, a first source of electromagnetic radiation, such as the first light source 20, is activated, thus causing one subset 30a of the quantum dots 30 to be excited to output light at a first wavelength to produce a first color. In some embodiments, the first light source 20 may be activated by a controller in response to receiving a first signal to produce the first color. At step 102, a second source of electromagnetic radiation, such as the second light source 22, is activated, thus causing another subset 30b of the quantum dots 30 to output light at a second wavelength to produce a second color. In some embodiments, the second light source 22 may be activated by a controller in response to receiving a second signal to produce the second color. At step 104, the first and second light sources 20, 22 are activated simultaneously or concurrently to excite both subsets of quantum dots 30 to output light at the first and second wavelengths to produce a blended color. At step 106, the first and second lights sources 20, 22 may be controlled separately at varying intensities to excite the different subsets of quantum dots 30 to output light at the first and second wavelengths, each having varying intensities to vary the blended color.

It will be appreciated that similar control methods may be performed in a different order than that described above. Similarly, it will be appreciated that additional steps may be performed with additional light sources and/or additional subsets of quantum dots 30, and that the control method described herein is not limited to that which is illustrated in the flow chart. For example, three or more light sources with three or more subsets of quantum dots may be selectively activated separately or simultaneously at different periods of time and at different intensities to produce additional colors.

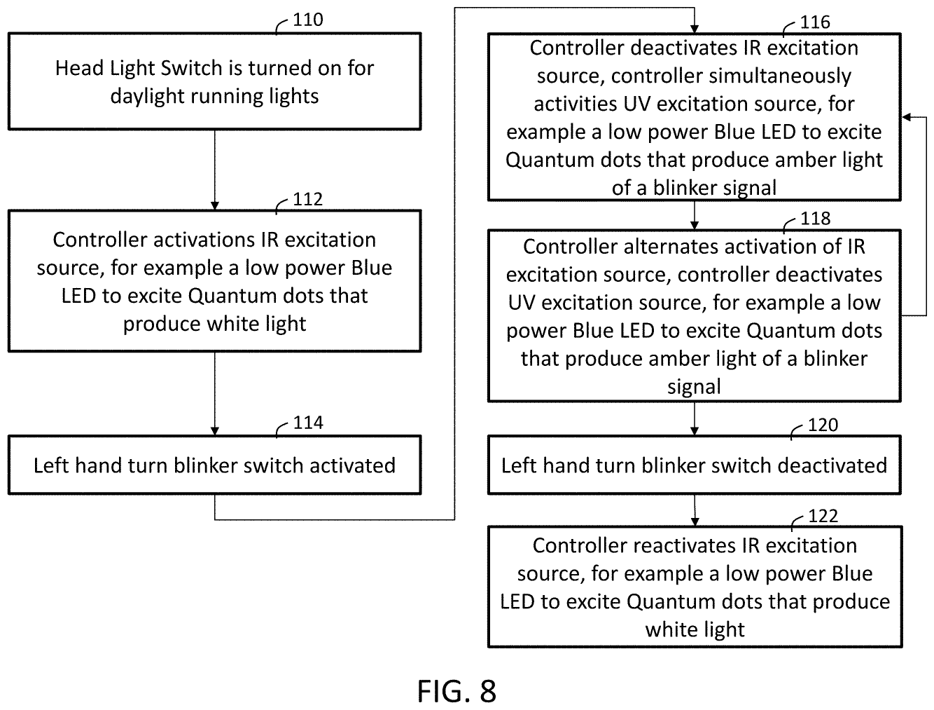

FIG. 8 illustrates a flow chart for yet another control example utilizing the above-described structure and abilities described herein. For example, FIG. 8 illustrates a control example for producing both daytime running white light and an amber turn signal light through a common lens. At step 110, the head light switch 34 may be activated for the daytime running light function. At step 112, the controller 24 activates the IR light source 22, for example a low power blue LED, to excite the quantum dots 30 that produce white light. At step 114, the turn signal switch 36 is activated. In response to step 114, at step 116 the controller 24 deactivates the IR light source 22, and the controller 24 activates the UV light source 20, for example a low power blue LED, to excite the quantum dots 30 that produce an amber light for the blinker signal. At step 118, the controller 24 alternates activation and deactivation of the UV light source 20, thereby alternating between producing the amber light and producing no light, such that a blinking light that blinks on and off is produced. At step 120, the turn signal switch 36 is deactivated. In response to step 120, at step 122 the controller 24 reactivates the IR light source 22 to produce the white light of the daytime running light. Thus, more than one color of light, being constant or intermittent, may be produced through the same lens, without requiring a separate colored lens portion as in the prior art.

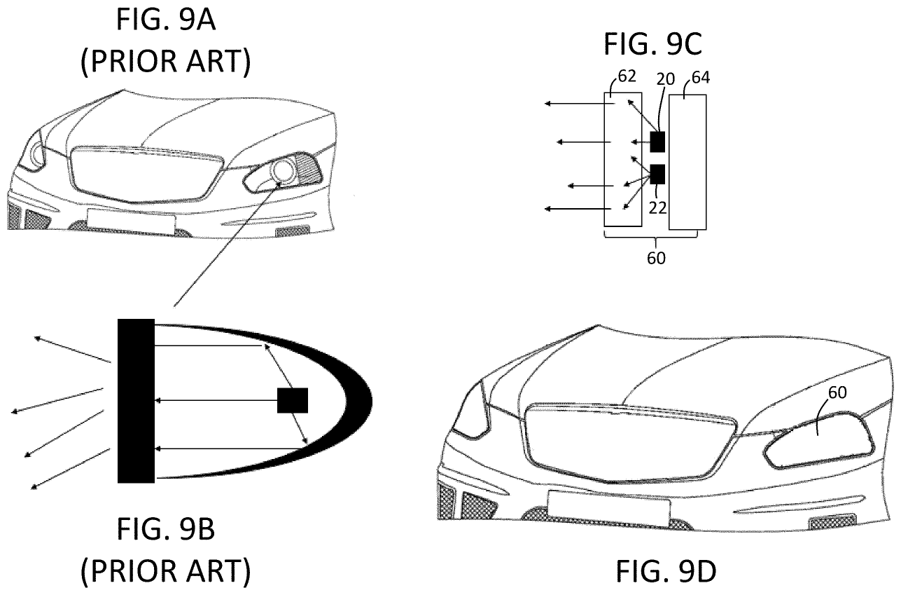

The above-described light module 32 may have a size and shape corresponding to a traditional light module, in which the light module 32 will intrude into the vehicle body, allowing for easy exchange with existing vehicle body designs. In this approach, the size and shape of the reflector 14 effectively defines the amount of intrusion into the vehicle body, and typically has a depth and curvature to allow the light to be focused onto the opposite lens 16. In the case of prior art light modules, such as that shown in FIGS. 9A and 9B, the lens or different colors are typically visible and the reflector is visible at least through the clear lens. The reflector is typically required to evenly distribute and focus the light, and thereby results in additional parts and deeper intrusion into the vehicle.

Turning now to FIGS. 9C and 9D, in another aspect, the light module 32 may be replaced with a low-profile assembly 60, thereby resulting in less instruction into the vehicle body. The assembly may include the quantum layer 18 in the form of a quantum dot doped panel 62. The panel 62 may include a plurality of quantum dots co-molded into the material of the panel 62, which may be a clear polymer material or the like. The assembly may further including a backing layer 64 disposed “behind” the panel 62 when the assembly is disposed on the vehicle, such that the panel 62 may be an “outer” component and the backing layer 64 may be considered an inner component. In other words, the backing layer 64 may be disposed behind the panel 62, with the panel 62 disposed between the backing layer 64 and a viewer.

In one approach, the light sources 20 and 22 may be disposed between the backing layer 64 and the panel 62. The backing layer 64 may be sheet metal or a similar rigid structure, and may have a generally flat profile. Alternatively, the backing layer 64 may have a curvature corresponding to the portion of the vehicle body where the assembly 60 is disposed.

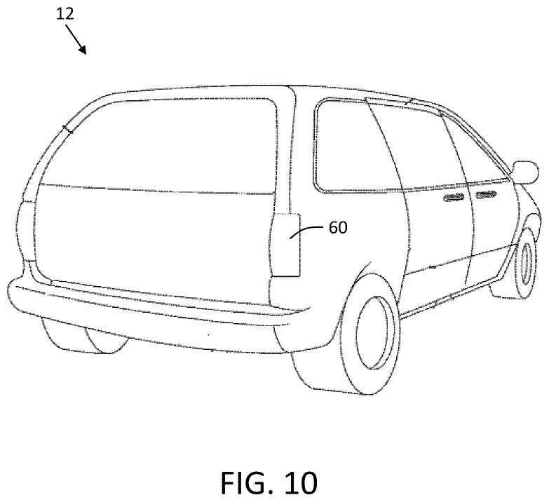

The quantum dot doped panel 62 may have a similar size, shape, and curvature as the backing layer 64, such that it may be flat or curved. The generally flat combined structure of the assembly 60 may thereby occupy a smaller amount of space relative to a traditional light module shape, thereby limiting intrusion into the vehicle body and providing area within the vehicle that can accommodate other structure or components. FIG. 10 illustrates an example of the assembly 60 being disposed at the rear of the vehicle.

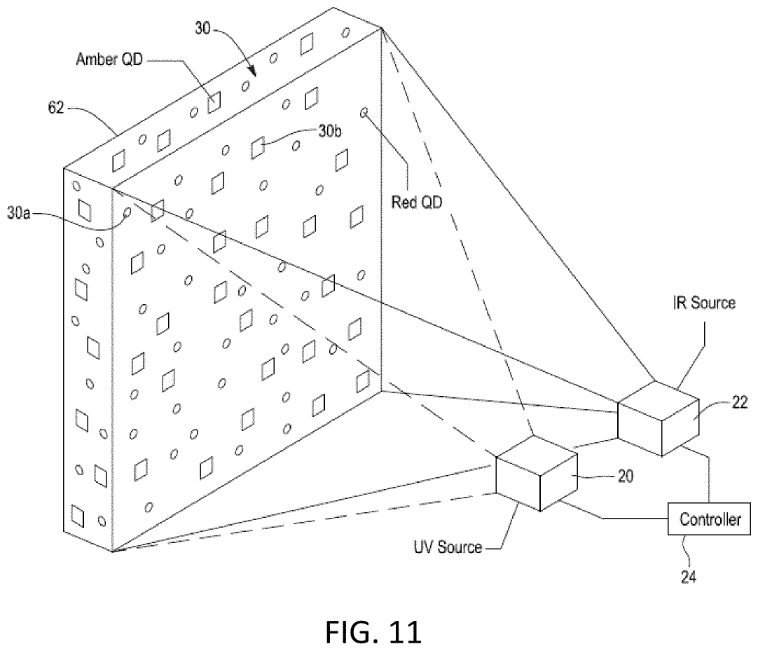

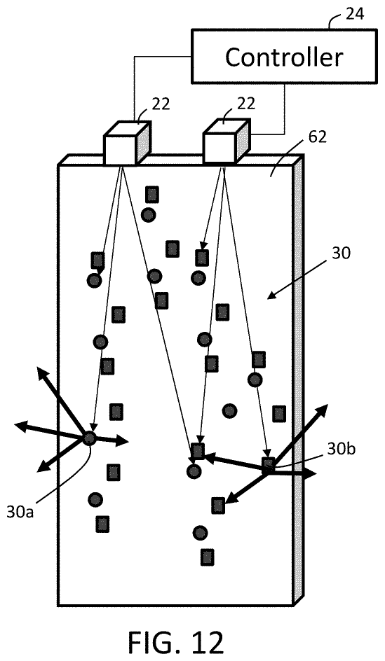

FIGS. 11 and 12 further illustrate exemplary arrangements of the assembly 60. In FIG. 11, the light sources 20, 22 are disposed behind the panel 62, such that the light sources 20, 22 would be between the panel 62 and the backing layer 64. In FIG. 12, the light sources 20, 22 are disposed adjacent the panel 62, meaning that the light sources 20, 22 are not between the panel 62 and the backing layer 64. Rather, the light sources 20, 22 are disposed laterally outside of the panel 62. In either case, the light sources 20, 22 may be operatively connected to the controller 24, which may control the light sources 20, 22 in a manner similar to that described above for the light module 32. The backing layer 64 is not shown in FIGS. 11 and 12. It will be appreciated that the backing layer 64 may be used with the embodiments illustrated in FIGS. 11 and 12. However, in an alternative approach, the backing layer 64 may be omitted as part of the assembly 60, and the panel 62 may be overlaid onto another structure or backing material.

When the light sources 20, 22 are selectively activated by the controller 24, the light sources 20, 22 will transmit light into and through the panel 62. The quantum dots 30 that are tuned to respond to the particular light source will become excited and will produce the intended light profile. The light may be refracted through the material of the panel 62 to reach the quantum dots 30 to excite the dots 30, and the produced light may further be refracted through the panel 62 to be outwardly displayed. In this approach, no reflector is used or necessary to produce the light.

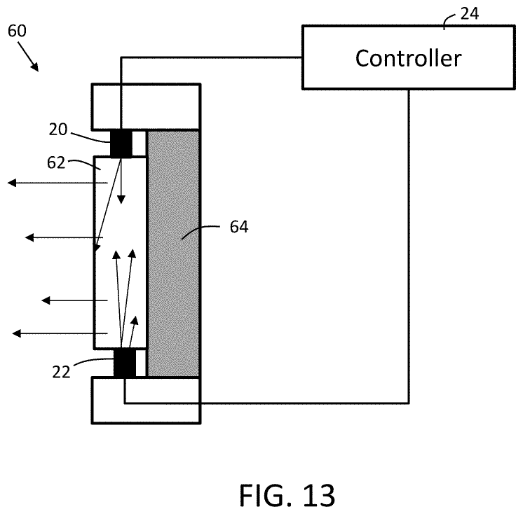

FIG. 13 illustrates another embodiment similar to that shown in FIG. 12, in which the light sources 20, 22 are disposed adjacent the panel 62, and illustrates the use of the backing layer 64. The light sources 20, 22 may be disposed on different side portions of the panel, such as opposite sides. Alternatively, the light sources 20, 22 may be disposed on the same outer edge of the panel 62, such as the position shown in FIG. 12.

The distribution of the quantum dots 30 within the various structures described herein, such as the layer 18, the lens 16, or the panel 62, have been described as being effectively intermixed in their distribution, such that different subsets of the quantum dots 30 to produce different light types are both distributed over effectively the entire structure. Thus, regardless of which color is produced, the light produced would emanate over the same area. However, other distribution patterns may be used to change the location and shape of the produced light.

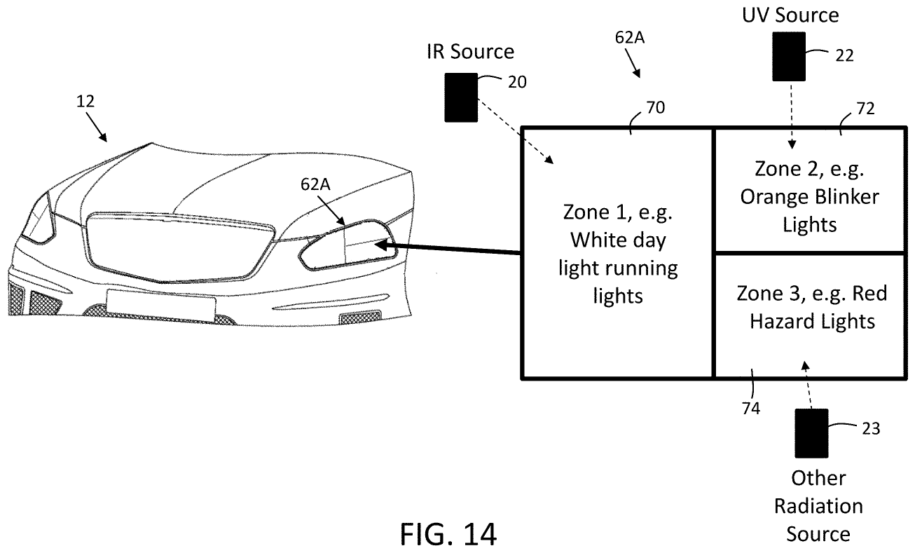

With reference to FIG. 14, a panel 62A may include a plurality of zones 70, 72, 74, with each of the different zones having a different subset of quantum dots 30 embedded therein. For example, each of the zones 70, 72, 74 may be doped with a different type of quantum dots 30. In one approach, a first zone 70, a second zone 72, and third zone 74 are defined on the panel 62A, with each zone having a different type of quantum dots 30. For example, the first zone 70 may be doped with quantum dots excitable by the first light source 20 to produce white daytime running lights. The second zone 72 may be doped with quantum dots 30 that are excitable by the second light source 22 to produce an amber blinker light color. The third zone 74 may be doped with a third type of quantum dots 30 that are excitable by a third radiation source 23 or spectral input to produce a red hazard light color. The light sources may be disposed behind the corresponding zones of the panel 62A or adjacent the corresponding zones of the panel 62A, similar to the light source disposition described above for the panel 62. The backing layer 64 may also be used with the panel 62A or omitted, as described above.

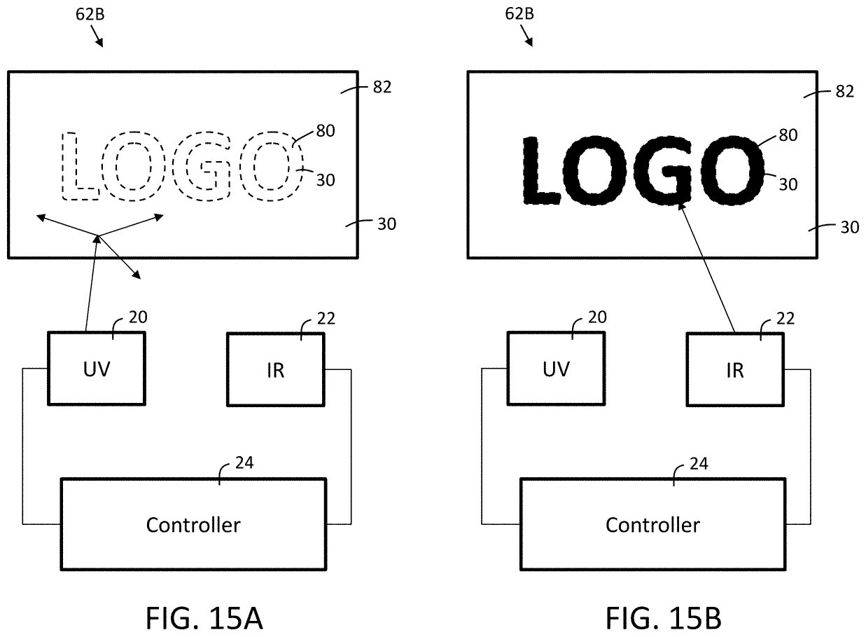

FIGS. 15A and 15B illustrate a similar arrangement to FIG. 14, in which different portions of a panel 62B have different types of quantum dots 30, which can produce different lighted shapes or areas depending on which light sources are activated. For example, as shown, a first zone 80 and a second zone 82 are defined on the panel 62A. The first zone 80 may form a mark, such as a logo, symbol, word, or other shape. The second zone 82 may surround the mark. The first zone 80 may include quantum dots 30 that are excitable by both the first and second light sources 20, 22. The second zone may include quantum dots 30 that are excitable by one of the light sources 20, 22. For example, when the UV light source 20 is activated, red quantum dots 30 may be activated in both of the zones 80, 82. When the IR light source 22 is activated, the second zone 82 may be illuminated, either as a separate color with the UV source turned off, or as a blended color with the UV source on at the same time as the IR source. The light sources 20, 22 may be disposed relative to the panel 62B in the manner described above, and the controller 24 may be used to selectively activate the light sources 20, 22 as desired.

It will be appreciated that various combinations of zones and distributions of quantum dots may be used to create different shapes and colors in response to activating one or more light sources to excite one or more types of quantum dots 30. For example, in the panel 62B, the first zone may include one type of quantum dot and the second zone 82 may include another type of quantum dot 30. Thus, by activating the quantum dots 30 of the first zone 80, the mark or logo may be defined using negative space, or may be combined with actuating the second zone 82 to create two illuminated zones without blended colors. Other arrangements will be apparent to those skilled in the art.

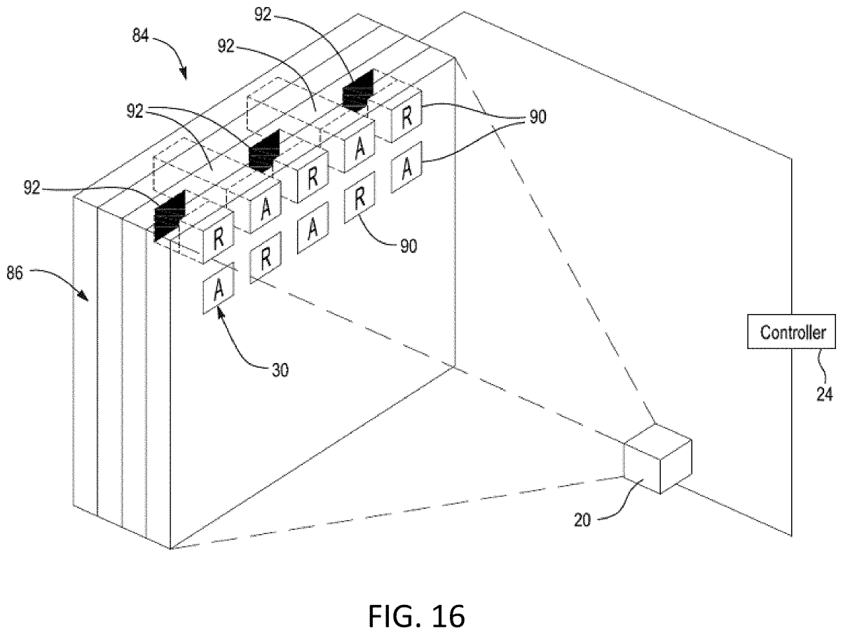

With reference to FIG. 16, in another approach, an assembly 84 may include a liquid crystal display (LCD) stack 86 including a plurality of LCD segments 92 and quantum dots 30 that are activated by the light source 20. The controller 24 may control the light source 20 to be selectively activated. The quantum dots may include a grid of QD illuminators 90, each of which being a region comprising a concentration of one or more quantum dots 30 having a similar type. For example, and as shown in FIG. 16, the QD illuminators 90 may be arranged as an alternating grid of amber-color QD illuminators 90 (having an abundance of amber quantum dots 30 labeled “A”), and other ones of the QD illuminators 90 may be configured as red-color QD illuminators 90 (having an abundance of red quantum dots 30, labeled “R”). The QD illuminators 90 may be configured as other colors and/or to produce light having a non-visible wavelength. The QD illuminators 90 may have any configuration and/or arrangement including any pattern of quantum dots 30 that are responsive to different colors/wavelengths of light. The LCD stack 86 may also be controlled by the controller 24 to activate LCD segments 92. Each of the LCD segments 92 may correspond to one or more of the QD illuminators 90. For example, when a turn signal is activated, the controller 24 may turn on the light source 20, which will activate both the red and amber quantum dots 30, and the controller 24 will activate the LCD stack to allow the amber-color QD illuminators 90 to be displayed while blocking the red-color QD illuminators 90 from being displayed. When a brake light is activated, the controller 24 will activate the same light source 20 (constantly instead of blinking), which will excite both the red-color and the amber-color QD illuminators 90, and the controller 24 will control the LCD stack 86 to block the amber-color QD illuminators 90 and display the red-color QD illuminators 90. Due to the concentration of the QD illuminators 90 and the LCD segments 92, both colors may appear to illuminate the same area.

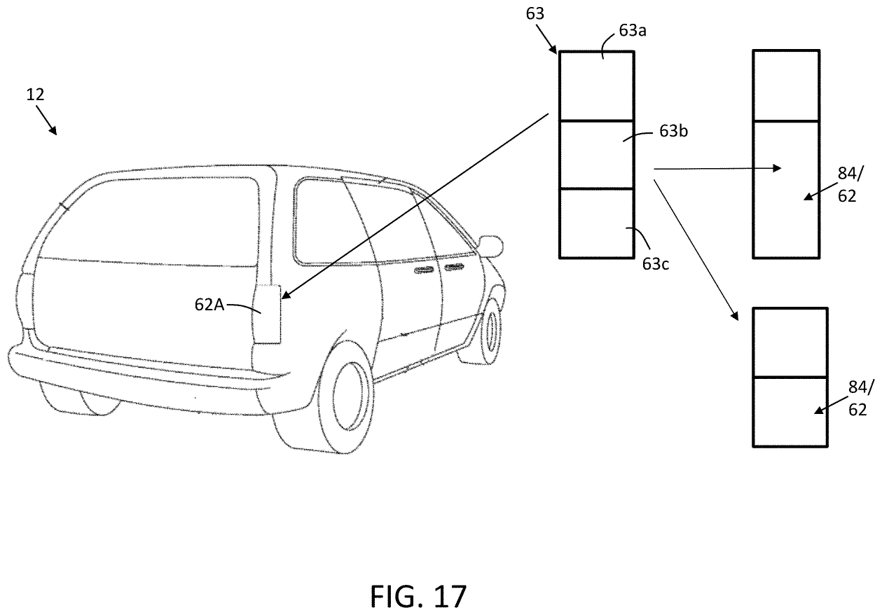

With reference to FIG. 17, by having an area of a panel that can display different colors over the same area, the surface area of the displayed light when compared to a prior art light module can be increased. For example, on a prior art light module 63 (shown in FIG. 17 being replaced by assembly 84 or panel 62), three separate areas 63a, 63b, 63c may be defined with different tinted lens to produce three different colors, effectively having three separate blocks. By combining two of the blocks into one to display two different colors, the area that displays each of the two colors may be increased. Alternatively, the size of the third block may be “deleted” and the resulting two block module can take up less vehicle space while maintain the same illuminated surface area for each color (when illuminated) as the prior art module, because one area can display more than one color, such as with panel 62 or assembly 84. Put another way, the turn signal and brake light may be combined into the same zone, and may either reduce the overall size of the module because of the reduction of zones, or may increase the size of the zone that displays the brake light/turn signal.

In view of the above, the use of the quantum dots 30 to generate different colors when illuminated by one or more light sources can provide for a variable color output from the same output area, whether it be a lens or a panel. Thus, the use of these quantum dots 30 may provide a robust and flexible solution, with potential for a reduction in size, weight, and cost, providing for additional manufacturing advantages.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A light assembly for a vehicle, comprising:
at least one source of electromagnetic radiation configured to emit electromagnetic radiation in at least a first direction;
a light output structure configured to display colors emitting therefrom;
a plurality of photo-luminescent particles, wherein a first subset of the plurality of photo-luminescent particles are configured to display a first color in response to excitation by the at least one source of electromagnetic radiation, and a second subset of the plurality of photo-luminescent particles are configured to display a second color in response to excitation by the at least one source of electromagnetic radiation; and
a controller in operative communication with the at least one source of electromagnetic radiation, the controller configured to selectively activate the at least one source of electromagnetic radiation for exciting one or both of the first and second subsets of the plurality of photo-luminescent particles in response to a signal.

2. The assembly of claim 1, wherein the at least one source of electromagnetic radiation includes a first source of electromagnetic radiation and a second source of electromagnetic radiation.

3. The assembly of claim 2, wherein the first subset of the plurality of photo-luminescent particles is configured to be excited by the first source of electromagnetic radiation, and the second subset of the plurality of photo-luminescent particles is configured to be excited by the second source of electromagnetic radiation.

4. The assembly of claim 3, wherein the first source of electromagnetic radiation is a UV light source and the second source of electromagnetic radiation is an IR light source.

5. The assembly of claim 1, wherein the plurality of photo-luminescent particles are embedded in the light output structure.

6. The assembly of claim 1, wherein the light output structure is a panel.

7. The assembly of claim 6, further comprising a backing layer disposed behind the panel with the panel disposed between the backing layer and a viewer.

8. The assembly of claim 7, wherein the at least one source of electromagnetic radiation is disposed between the backing layer and the panel.

9. The assembly of claim 7, wherein the at least one source of electromagnetic radiation is disposed at an outer edge of the panel.

10. The assembly of claim 6, wherein the panel includes a plurality of zones, wherein each zone of the plurality of zones has a different subset of photo-luminescent particles embedded therein.

11. The assembly of claim 6 further comprising a controllable LCD stack, wherein the controllable LCD stack is controllable to selectively block a QD illuminator comprising one of the first or the second subset of the photo-luminescent particles, and wherein the first and the second subsets of the photo-luminescent particles are excitable by a same one of the at least one source of electromagnetic radiation.

12. The assembly of claim 1, wherein the light output structure is a lens.

13. The assembly of claim 12, wherein substantially the entire lens is a clear lens, and excitation of the first subset produces the first color through the clear lens and excitation of the second subset produces the second color through the clear lens.

14. The assembly of claim 13, wherein excitation of both subsets of the plurality of photo-luminescent particles simultaneously produces a blended color.

15. The assembly of claim 12, further comprising a reflector disposed opposite the lens.

16. The assembly of claim 15, wherein the plurality of photo-luminescent particles are disposed on a layer over the reflector.

17. The assembly of claim 15, wherein the lens includes the first subset or the second subset of the plurality of photo-luminescent particles, wherein light reflected off the reflector is focused by the lens and light produced by the photo-luminescent particles of the lens produces diffuse light therefrom.

18. The assembly of claim 15, wherein light produced by the photo-luminescent particles reflects off of the reflector and is directed to the lens.

19. The assembly of claim 1, wherein the photo-luminescent particles are quantum dots.

20. A method for producing different colors in a light assembly, the method comprising;
at a controller, receiving a first signal to produce to a first color;
in response to receiving the first signal, activating a first source of electromagnetic radiation;
receiving electromagnetic radiation from the first source of electromagnetic radiation at a first subset of photo-luminescent particles and, in response thereto, exciting the first subset of photo-luminescent particles to produce the first color;
at the controller, receiving a second signal to produce a second color;
in response to receiving the second signal, activating a second source of electromagnetic radiation;
receiving electromagnetic radiation from the second source of electromagnetic radiation at a second subset of photo-luminescent particles and, in response thereto, exciting the second subset of photo-luminescent particles to produce the second color.

21. The method of claim 20, wherein the first source of electromagnetic radiation is deactivated prior to activating the second source of electromagnetic radiation.

22. The method of claim 20, wherein activating the second source of electromagnetic radiation includes alternating between an activated and deactivated state multiple times.

23. The method of claim 20, wherein the first source of electromagnetic radiation and the second source of electromagnetic radiation are activated simultaneously to produce a blended color.

24. The method of claim 23, further comprising varying an intensity of at least one of the first source of electromagnetic radiation or the second source of electromagnetic radiation to produce a varying blended color.
